(19) United States
(12) Patent Application Publication
(10) Pub. No.: US 2012/0113109 A1
(43) Pub. Date: May 10, 2012

(54) METHOD AND APPARATUS FOR SEARCHING FOR IMAGE DATA

(75) Inventor: Sang-Kyung LEE, Anyang-si (KR)

(73) Assignee: Samsung Electronics Co., Ltd., Suwon-si (KR)

(21) Appl. No.: 13/291,586

(22) Filed: Nov. 8, 2011

(30) Foreign Application Priority Data
Nov. 8, 2010 (KR) 10-2010-0110682

(51) Int. Cl. G06T 15/00; G06K 9/64

(52) U.S. Cl. 345/419; 382/154

(57) ABSTRACT

A method and apparatus are provided for searching for image data by generating a search query including depth information of an image in order to search for the image data; and searching for image data by comparing the depth information included in the search query with depth information of the image data to be searched.

### PRIORITY

This application claims priority under 35 U.S.C. §119(a) to a Korean Patent Application filed in the Korean Intellectual Property Office on Nov. 8, 2010 and assigned Serial No. 10-2010-0110682, the entire disclosure of which is incorporated herein by reference.

### BACKGROUND OF THE INVENTION

1. Field of the Invention

The present invention relates generally to a technology for searching for data, and more particularly to a method and an apparatus for searching for image data.

2. Description of the Related Art

Generally, image data is searched using a metadata scheme of searching for desired image data, by using metadata which includes text information or tag information associated with relevant image data. FIG. 1A and FIG. 1B are diagrams illustrating search schemes, respectively, when a typical search is made for image data. Referring to FIG. 1A, the text information “apple,” together with image data, is stored in an apple image. Here, a search may be made for apple image data by using the text “apple” as a search keyword.

Another scheme of searching for image data is a Content-Based Image Retrieval (CBIR) scheme. In a CBIR scheme, a search is made for image data by using visual features of the image. As illustrated in FIG. 1B, the CBIR scheme is a method of searching for an image by using features including colors, textures, the shapes of the objects of an image, and the like. The texture of an image is information used to represent surface information of an object.

In a search scheme using metadata there may be a discrepancy between metadata and actually found image data because metadata does not describe every feature of actual image data. For example, when a user searches for “apple,” the user may find an apple image as well as a face image having “a face like an apple” as metadata text. As described above, the search scheme using metadata has a disadvantage in that images other than desired images may be found.

In the CBIR scheme, visual features of an actual image are extracted and stored in a database. Therefore, the CBIR searching scheme has a higher accuracy than the metadata searching scheme. However, the CBIR scheme also does not guarantee perfect accuracy because data may be lost when extracting the features of image data and accuracy may be decreased due to difficulties in identifying the extracted features.

Additionally, with the recent increased interest in three-dimensional stereoscopic images, which are captured by using multiple cameras, the stereoscopic image data tends to have an increased amount of image data Therefore, a more accurate search technology is required for stereoscopic image data.

### SUMMARY OF THE INVENTION

Accordingly, the present invention has been made to solve the above-mentioned problems occurring in the prior art, and the present invention provides a method and an apparatus, by which a more accurate search can be made for image data, than in an existing search scheme, by using features of stereoscopic image data when searching.

According to an aspect of the present invention, there is provided a method of searching for image data by generating a search query including depth information of an image by including the depth information of the image in the search query, in order to search for the image data; and searching for image data by comparing the depth information included in the search query with depth information of the image data to be searched.

According to another aspect of the present invention, there is provided an apparatus for searching for image data. The apparatus includes an input unit for receiving an input from a user; a display unit for displaying a content of an output; a storage unit for storing information necessary for an operation of the apparatus for searching for the image data; a graphic processor for extracting a depth map of image data; and a controller for generating a search query including depth information of an image by including the depth information of the image in the search query, and searching for image data by comparing the depth information included in the search query with depth information of the image data to be searched.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other features, aspects, and advantages of the various embodiments of the present invention will be more apparent from the following detailed description taken in conjunction with the accompanying drawings, in which:

FIG. 1A and FIG. 1B are diagrams illustrating search schemes, respectively, when a typical search is made for image data;

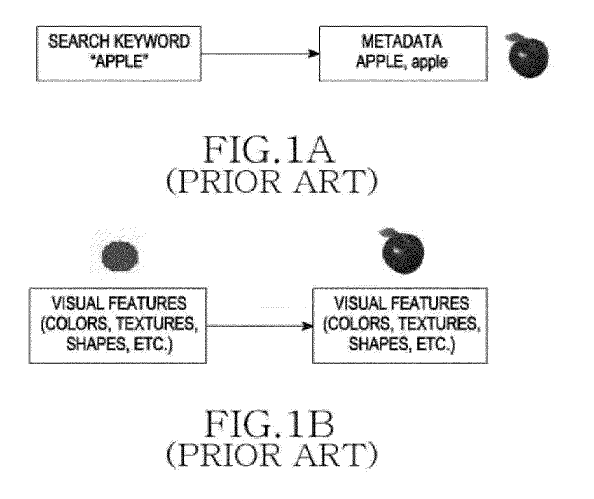

FIG. 2A and FIG. 2B are diagrams illustrating search schemes, respectively, when a search is made for image data according to an embodiment of the present invention;

FIG. 3 is a block diagram illustrating the configuration of an apparatus for searching for image data according to an embodiment of the present invention;

FIG. 4 is a block diagram illustrating a detailed configuration of an apparatus for searching for image data according to an embodiment of the present invention;

FIG. 5 is a flowchart illustrating a method of searching for image data according to an embodiment of the present invention; and

FIG. 6A, FIG. 6B and FIG. 6C are diagrams illustrating three schemes of searching for image data according to an embodiment of the present invention, respectively.

### DETAILED DESCRIPTION OF EMBODIMENTS OF THE PRESENT INVENTION

Various embodiments of the present invention will be described in detail with reference to the accompanying drawings. The following description includes specific details such as detailed components and configurations, which are only provided to assist the overall understanding of various embodiments of the present invention. Therefore, it will be apparent to a person having ordinary skill in the art of the present invention that various changes and modifications of the embodiments may be made without departing from the scope and spirit of the present invention.

The embodiments of the present invention provide a method and an apparatus, by which a more accurate search can be made for image data, than in an existing search scheme, by using depth information of image data obtained by configuring as data a degree of relative depth between objects of a stereoscopic image, when the search is made for the stereoscopic image data. When a search is made for an image by using a depth map template according to the present invention, a previously set depth map template is provided to a user, a search is made for image data by using depth information of a depth map template selected by the user, and then stereoscopic image data is found. Additionally, when a search is made for an image by using a depth map generation tool, according to an aspect of the present invention, the user directly generates a depth map by using the depth map generation tool. The image is generated in such a manner as to locate a standardized three-dimensional object and adjust a viewpoint of a camera in a virtual space. Then, a search is made for image data by using depth information of the generated image. When a search is made for an image by using a preview stereoscopic image according to the present invention, a depth map is extracted by analyzing a stereoscopic image, which has been received as input or has been captured, and a search is made for image data by using depth information of the extracted depth map.

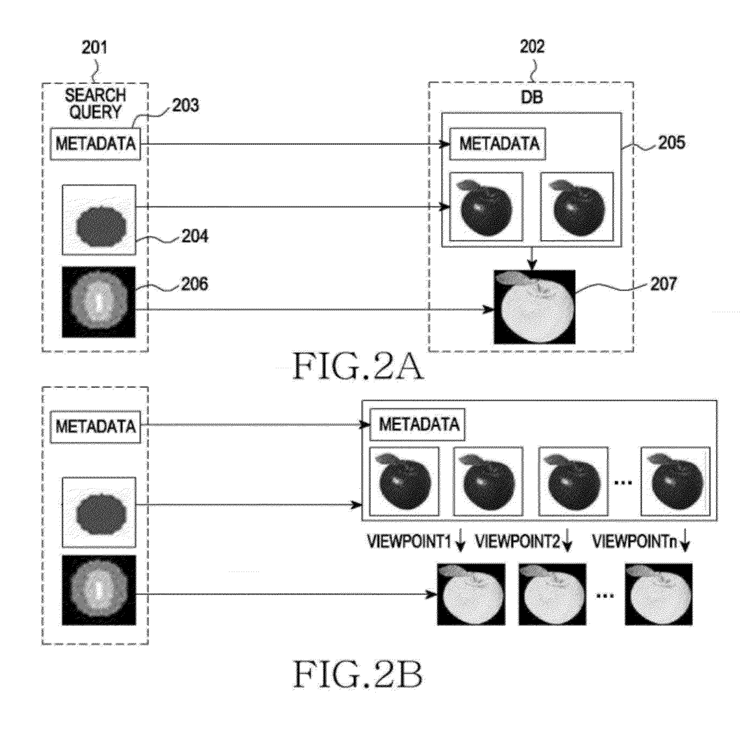

FIG. 2A and FIG. 2B are diagrams illustrating search schemes, respectively, when a search is made for image data according to an embodiment of the present invention.

Referring to FIG. 2A, when a typical search is made for image data, the search is performed by using a search query 201 in such a manner as to compare data of a DataBase (DB) 202 with the search query 201. When a search is performed according to the present invention, depth information 206 of a stereoscopic image is used in addition to text information 203 used to search for the existing metadata and visual features 204 representing colors, textures and shapes of an image for the CBIR scheme. The texture of an image is information used to represent surface information of an object. A search query used in the present invention includes text information 203, visual features 204 and depth information 206. Stereoscopic image data 205, generally, includes metadata and contains two images including a left image and a right image, and a depth map 207 defined in the format thereof. When a search is made for image data, an operation for extracting a depth map, i.e. depth information 207, of an image stored in a database is performed, and then an operation for comparing depth information 206 included in a search query with the extracted depth information 207 is performed. By using this comparison, a database 202 which stores image data may be searched for image data corresponding to the search query.

Referring to FIG. 2B, a similar search scheme is used even for a multi-viewpoint stereoscopic image. Here, a depth map may be extracted at each viewpoint, and a search is made for image data by comparing depth information of the extracted depth map with depth information of a search query.

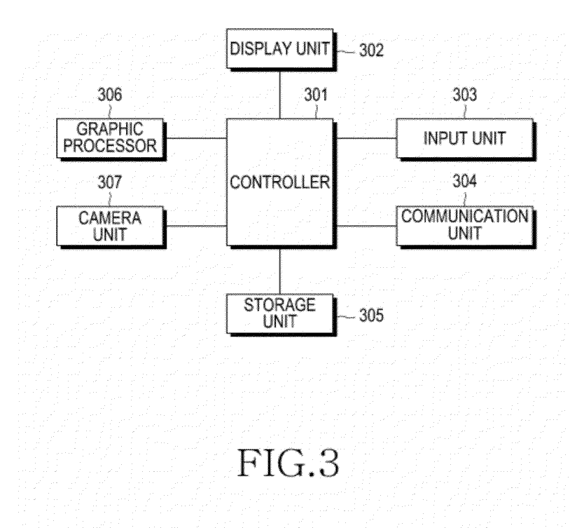

FIG. 3 is a block diagram illustrating the configuration of an apparatus for searching for image data according to an embodiment of the present invention which includes a display unit 302, an input unit 303, a communication unit 304, a storage unit 305, a camera unit 307, a graphic processor 306, and a controller 301.

The display unit 302 may be implemented by using a display device such as a Liquid Crystal Display (LCD), and includes a display device capable of outputting a three-dimensional image such as a stereoscopic image or a multi-viewpoint image. According to an embodiment of the present invention, when a scheme of searching for an image by using a depth map template is performed, the display unit 302 displays and provides a previously set depth map template list to a user. Otherwise, when a scheme of searching for an image by using a depth map generation tool is performed, the display unit 302 displays and provides a depth map generation tool to a user. Furthermore, when a scheme of searching for an image by using a preview stereoscopic image is performed, the display unit 302 displays and provides a preview stereoscopic image to a user.

The input unit 303 may be implemented by using an input means such as a physical keypad, a physical touch screen or the like, and delivers an input signal received from a user, to the controller 301.

The communication unit 304 communicates with another device in a wired or wireless communication scheme. According to an embodiment of the present invention, the communication unit 304 communicates with an image database which stores stereoscopic image data. The communication unit 304 may transmit a search query generated by the controller 301 to an image data database.

The storage unit 305 stores information necessary for the operation of the apparatus for searching for image data according to the present invention. Also, when a database is included in the apparatus for searching for image data, stereoscopic image data may be stored in the database, and preview image data to be used in a search of image data or a depth map template may be stored.

The term “depth map template” refers to data obtained by extracting a feature of a representative sense of depth, which an image may have, and standardizing the extracted feature of the representative sense of depth.

The camera unit 307 includes an image sensor and a lens (not shown), and captures an object to be captured and generates image data. The camera unit 307 may be implemented as a stereo camera for generating a stereoscopic image.

The graphic processor 306 extracts a depth map image data, which has been input through an input unit 303, image data captured by the camera unit 307, a depth map template stored in the storage unit 305, or from a preview image.

A controller 301 controls units of the apparatus for searching for image data, and includes depth information of the depth map, which has been extracted by the graphic processor 306, in a search query and generates the search query including the depth information of the depth map.

The controller 301 includes depth information of an image in a search query and generates the search query including the depth information of the image. Then, the controller 301 performs a control operation of comparing the depth information included in the search query with depth information of image data to be searched and searching for image data.

When the controller 301 generates a search query including depth information of an image, the controller 301 controls the display unit 302 to display a previously set depth map template, controls the input unit 303 to receive information on a depth map template selected by a user, performs a control operation for extracting a depth map of the depth map template selected by the graphic processor 306, and includes depth information of the extracted depth map in a search query and generates the search query including the depth information of the extracted depth map.

The term “depth map template” refers to image data obtained by extracting features of multiple pieces of depth information, which an image may have and have previously been set, and standardizing the extracted features of the multiple pieces of depth information.

When the controller 301 generates a search query including depth information of an image, the controller 301 controls the display unit 302 to display a depth map generation tool which allows a user to directly generate a depth map, performs a control operation for determining depth map data generated by the depth map generation tool, and includes depth information of the depth map generated by the depth map generation tool in a search query and generates the search query including the depth information of the depth map.

Determining the depth map data generated by the depth map generation tool includes locating an optional three-dimensional object in a three-dimensional virtual space, placing a virtual camera in the three-dimensional virtual space, and extracting a depth map of an image captured by the virtual camera. Also, the depth map generation tool provides a means capable of adjusting the position of the virtual camera and a direction in which an image is captured by the virtual camera, and provides a means capable of adjusting the shape, the position and the size of the three-dimensional object.

When the controller 301 generates a search query including depth information of an image, the controller 301 performs a control operation for extracting a depth map of an image previously set by the graphic processor 306, and includes depth information of the extracted depth map in a search query and generates the search query including the depth information of the extracted depth map. The previously set image may be an image captured by a camera or a previously stored image.

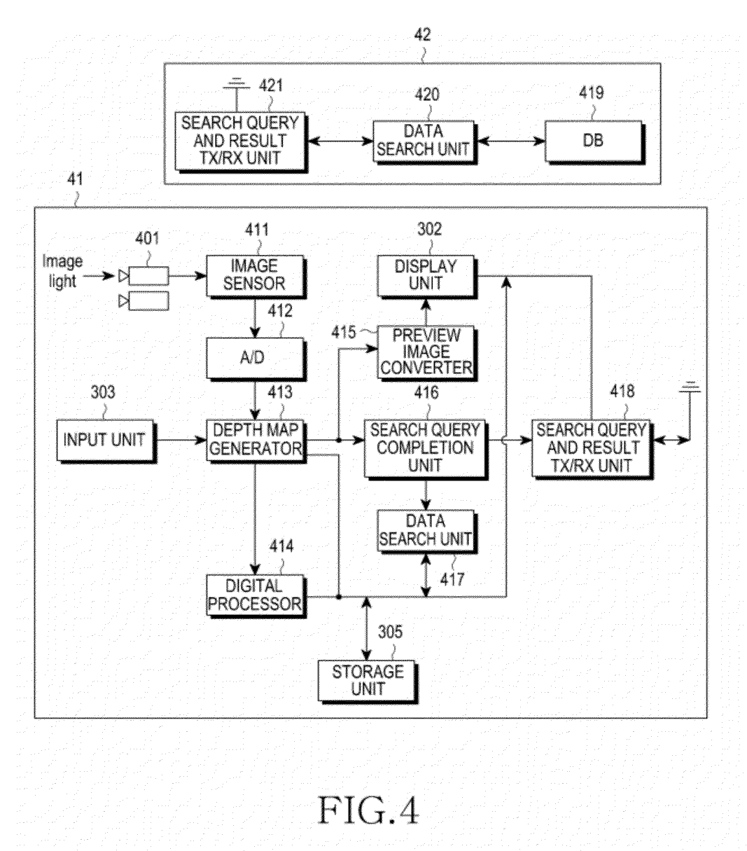

FIG. 4 is a block diagram illustrating a detailed configuration of an apparatus for searching for image data according to an embodiment of the present invention. FIG. 4 is a diagram illustrating the configuration of an apparatus for searching for image data according to the search operation when the search is made for image data in an image data searching scheme using a preview image.

When performing a search operation, an apparatus 41 for searching for image data, first receives as input an image signal through a stereo camera 401, which may be mounted on the apparatus 41, and then an image sensor 411 senses the received image signal and stores the sensed image signal as an analog signal. Such an analog signal goes through an Analog-to-Digital (A/D) converter 412, and is converted to a digital signal. A depth map generator 413 extracts a depth map by performing image processing on the input binocular image.

To search for an image in a database outside the apparatus 41, after the degree of similarity of a search keyword of a search query, which has been input through the input unit 303, with a depth map first received as input from an external input and the extracted depth map is constructed by a search query completion unit 416, a query is transmitted to the database outside the apparatus 41 through a search query and result Tx/Rx unit 418.

A database 42 includes a search query and result Tx/Rx unit 421, a data search unit 420, and a database storing unit (DB) 419. The database 42 receives a search query from the apparatus 41 for searching for image data through the search query and result Tx/Rx unit 421, searches the DB 419, which stores stereoscopic image data, through the data search unit 420, and transmits a result of the search back to the apparatus 41 for searching for image data.

When it is intended to search for data stored in a storage unit 408 included in the apparatus for searching for image data without using the database outside the apparatus 41, a search query constructed by a search query completion unit 416 is delivered to a data search unit 417. The data search unit 417 searches for an image, which is similar to the search query, by comparing an image stored in the storage unit 305 with a search query. After the search, a result of the search is delivered to the display unit 302, and is displayed thereby.

A preview image converter 415 first performs a conversion on a preview image used for the search and then delivers to the converted preview image to the display unit 302, to display the converted preview image.

A digital processor 414 performs conversion of raw data captured by an existing digital device to data in a format such as Joint Photographic Experts Group (JPEG), Moving Picture Experts Group (MPEG), or the like.

Each of the data search units 417 and 420 compare depth information included in a search query with depth information of an image to be searched. A depth map includes data having features identical to two-dimensional image data where each pixel has a depth value, and an algorithm for calculating a degree of similarity may be used, by comparing depth information included in a search query with depth information of an image.

The stereo camera 401, the image sensor 411 and the A/D converter 412 shown in FIG. 4 correspond to the camera unit 307 shown in FIG. 3. The depth map generator 413 and the digital processor 414 shown in FIG. 4 correspond to the graphic processor 306 shown in FIG. 3. The preview image converter 415, the search query completion unit 416 and the data search unit 417 shown in FIG. 4 correspond to the controller 301 shown in FIG. 3. The search query and result Tx/Rx unit 418 and an antenna shown in FIG. 4 correspond to the communication unit 304 shown in FIG. 3.

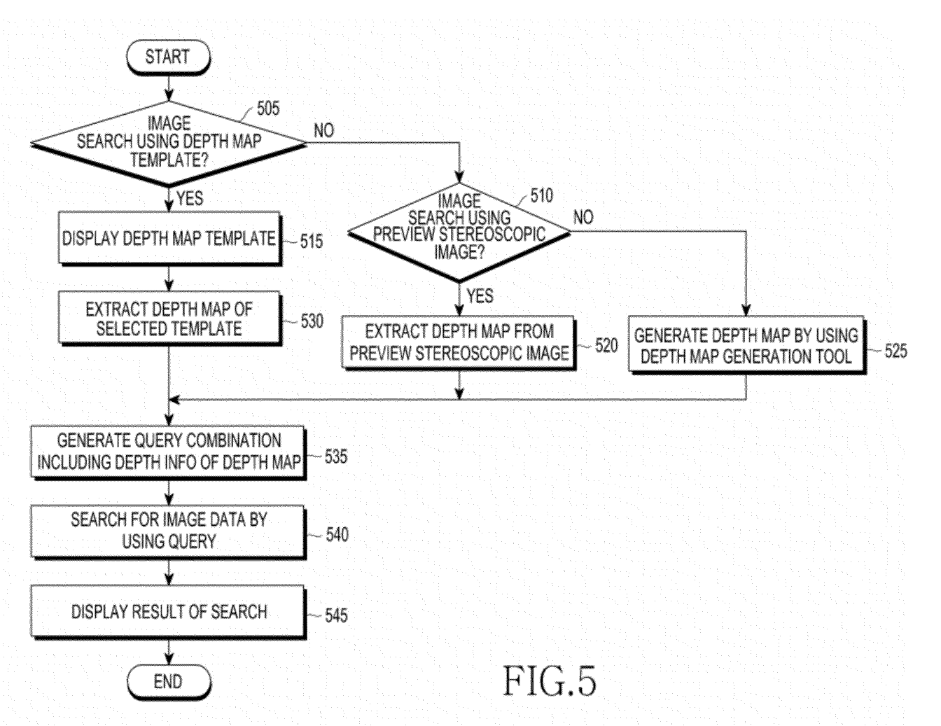

FIG. 5 is a flowchart illustrating a method of searching for image data according to an embodiment of the present invention. Referring to FIG. 5, first, a determination is made in step 505 as to whether a search for image data employs a scheme of searching for an image by using a depth map template. When a result of the determination in step 505 shows that the search for image data employs the scheme of searching for an image by using a depth map template, the process proceeds to step 515. In step 515, a previously set depth map template list is displayed by the display unit 302 in order to provide the previously set depth map template list to a user. In step 520, a depth map of a depth map template selected by the user is extracted, and the process proceeds to step 535.

When the result of the determination in step 505 shows that the search for image data does not employ the scheme of searching for an image by using a depth map template, the process proceeds to step 510. In step 510, a determination is made as to whether the search for image data employs a scheme of searching for an image by using a preview stereoscopic image, and if so, the process proceeds to step 520. In step 520, a depth map is extracted from a preview stereoscopic image, and the process proceeds to step 535. The preview stereoscopic image may be a stereoscopic image captured by the camera unit 307 or a previously stored a stereoscopic image.

When the result of the determination in step 510 shows that the search for image data does not employ the scheme of searching for an image by using a preview stereoscopic image, the process proceeds to step 525. In step 525, it is determined that the search for image data employs a scheme of searching for an image by using a depth map generation tool, so that a depth map generation tool is first provided to the user and then a depth map is generated by using the provided depth map generation tool. Thereafter, the process proceeds to step 535.

In step 535, a search query including depth information of the depth map is generated. In step 540, a database is searched for image data by using the generated search query. In step 545, a result of the search is displayed, and the process is completed.

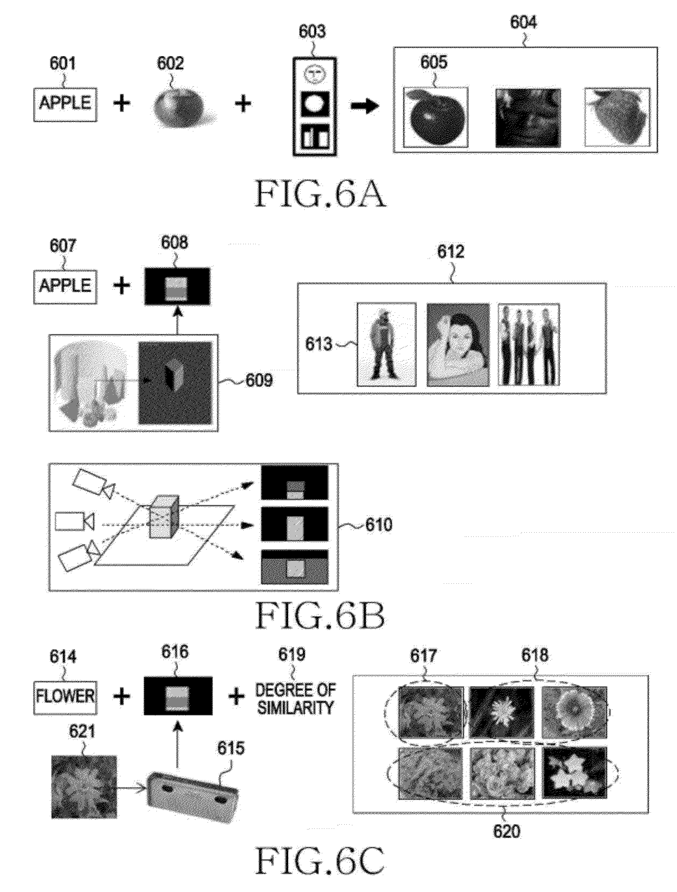

FIG. 6A, FIG. 6B and FIG. 6C are diagrams illustrating three schemes of searching for image data according to an embodiment of the present invention, respectively.

In one scheme of searching for an image by using a depth map template, a template obtained by standardizing a depth map is first provided to a user and then the provided template allows the user to select depth information, so that a search is made for an image having a depth map similar to the selected depth information.

Referring to FIG. 6A, in the scheme of searching for an image by using a depth map template, depth information of the depth map template is added to a search query including the existing metadata search scheme or the CBIR search scheme. For example, in order to search for “an apple,” although a search is made for “apple” by using metadata 601 and a CBIR 602, an image which does not match with what is intended, may be found. In this respect, because the user searches for an apple corresponding to a round object having the depth of a curved surface, search accuracy is improved by enabling the user to select a depth map template 603 matching the apple. Accordingly, an apple image 605 may be found as a result of comparing an image stored in a DB 604 with a search query. A standardized depth map template is a template obtained by standardizing features of a representative depth appearing in a photograph. When a search is performed, a selected depth map template is compared with an overall sense of depth of a target image, and the selected depth map template is compared with a partial sense of depth. Then, both a degree of similarity of the selected depth map template with the overall sense of depth of the target image, and a degree of similarity of the selected depth map template with the partial sense of depth are calculated.

In another scheme of searching for an image by using a depth map generation tool, the depth map generation tool is provided to the user so that the user can directly generate a depth map.

Referring to FIG. 6B, a depth map generation tool generates information on a three-dimensional space based on computer graphics. The user drags and locates a three-dimensional object in a virtual space as denoted by reference numeral 609, and places a virtual camera, so that the user may generate a sense of depth of a scene, for which the user intends to search, as denoted by reference numeral 610. The user may adjust a viewpoint and a direction of the camera, a shape, a position and a size of the object, and the like, through the depth map generation tool. Therefore, a search may be made for a desired image by using information 607 of the existing metadata and the depth information 608 generated by the depth map generation tool.

For example, when a search is made for “person,” photographs showing various poses and photographs of many persons are found as a result of the search. When an image desired by a user is an image which shows a person standing alone and has been captured from front view of the person, a person-shaped object is located in a virtual space through the depth map generation tool as denoted by reference numeral 609, and a virtual camera is located in front of the object through the depth map generation tool as denoted by reference numeral 610. Then, a depth map of a shape of the person-shaped object standing alone is generated, and an image 613 having a depth map, which is similar to the depth map of the shape among candidate images of a DB 612, may be found. The depth map generation tool adjusts a viewpoint and a position of the virtual camera, and thus designates a viewpoint desired by the user in a query. Therefore, a stereoscopic image captured at the desired viewpoint may be found. Namely, generated depth maps may be different depending on positions of the virtual camera, so that a query can be specifically customized.

In the scheme of searching for an image by using a depth map generation tool, a search query is completed through the following process. By applying an input signal, which is input from the input unit 303, to the depth map generation tool, a virtual object is located in a virtual space. A viewpoint value and a position value of the virtual camera are determined, and the determined viewpoint and position values may be converted to a data format having position information in a three-dimensional space. The depth map generator 413 sets the z-axis from a zero parallax point and the position of the virtual camera which have been set in the virtual space, and extracts depth values of objects placed from the set z-axis. The depth map generator 413 generates a depth map identical to a depth map of a binocular image captured by an optical device, by using the extracted depth values as described above.

Referring to FIG. 6C, in a scheme of searching for an image by using a preview image, a depth map 616 of an image 621 captured by a device 615 having dual cameras for a stereo image or that of a stereoscopic image 621 which is input for preview is used in a search, together with a search keyword such as the existing metadata 614, etc. The preview image may be a previously stored image.

According to the present invention, information on a degree of similarity 619 of depth information of a depth map is further included in a search query, so that user intention can be reflected in the search query. For example, in the scheme of searching for an image by using a preview image, when the user desires to know what an object is in an image being input for preview, the user may first increase the degree of similarity of a depth map and then search for the object. For example, when a user desires to know the name of a flower that the user is currently viewing, the metadata “flower,” a depth map generated from a preview image and a high degree of similarity are set to account for the differences in detail between various flowers. Although the metadata “flower” alone causes millions of flowers to be found, due to the shape of the flower extracted from the depth map, the set higher degree of similarity, the probability of finding the flower that the user is currently viewing increases. Also, when the user intends to search for another image having the general composition of a captured image, which the user has set, the user may first set a low degree of similarity and then find images 618 having a composition of the captured image, which are similar to the composition set by the user. For example, when the user designates the keyword “flower” and a high degree of similarity in a search query in the right section of FIG. 6C, the user has a high possibility of finding an image such as an image 617, which is identical to an image 621 that the user has originally desired. On the other hand, when the user sets a low degree of similarity, similar images such as the images 618, which have similar compositions, may be found. Images such as images 620, which are not related to the search query, are not found. It is possible to set and use the degree of similarity of depth information as described above even in other schemes.

As described above, the method and the apparatus for searching for image data according to the present invention can be applied to an image or a moving image, such as stereoscopic image data, stored in a format such that depth information may be included in an image or may be extracted therefrom. The method and the apparatus according to the present invention have an advantage in that the search accuracy of stereoscopic image data can be improved. Also, a user may add depth information to a search query, so to construct a more customized search query than the existing search methods.

While the present invention has been described with reference to various embodiments thereof, it will be understood by those of ordinary skill in the art that various changes in form and detail may be made therein without departing from the spirit and scope of the present invention as defined by the appended claims.

What is claimed is:

1. A method of searching for image data, the method comprising:
generating a search query including depth information of an image in order to search for the image data; and
searching for image data by comparing the depth information included in the search query with depth information of the image data to be searched.

2. The method as claimed in claim 1, wherein generating the search query further comprises:
displaying a previously set depth map template;
receiving, as an input, information on a depth map template selected by a user;
extracting a depth map of the selected depth map template; and
generating a search query including depth information of the extracted depth map by including the depth information of the extracted depth map in the search query.

3. The method as claimed in claim 2, further comprising:
extracting features of multiple pieces of depth information of an image which have been previously set; and
standardizing the extracted features of the multiple pieces of depth information.

4. The method as claimed in claim 1, wherein generating the search query further comprises:
displaying a depth map generation tool for generating a depth map;
determining depth map data generated by the depth map generation tool; and
generating a search query including depth information of the depth map generated by the depth map generation tool.

5. The method as claimed in claim 4, wherein determining the depth map data generated by the depth map generation tool comprises:
locating an optional three-dimensional object in a three-dimensional virtual space;
placing a virtual camera in the three-dimensional virtual space; and
extracting a depth map of an image captured by the virtual camera.

6. The method as claimed in claim 5, wherein the depth map generation tool adjusts a position of the virtual camera and a direction in which an image is captured by the virtual camera, and adjusts a shape, a position and a size of the three-dimensional object.

7. The method as claimed in claim 1, wherein generating the search query further comprises:
extracting a depth map of a previously set image; and
generating a search query including depth information of the extracted depth map.

8. The method as claimed in claim 7, wherein the previously set image includes an image captured by a camera or a previously stored image.

9. An apparatus for searching for image data, the apparatus comprising:
an input unit for receiving input from a user;
a display unit for displaying content;
a storage unit for storing information necessary for searching the image data;
a graphic processor for extracting a depth map of image data; and
a controller for generating a search query including depth information of an image and for searching the image data by comparing the depth information included in the search query with depth information of the image data to be searched.

10. The apparatus as claimed in claim 9, further comprising a communication unit for transmitting the generated search query to a database.

11. The apparatus as claimed in claim 9, wherein, when the controller generates the search query including the depth information of the image, the controller controls the display unit to display a previously set depth map template, controls the input unit to receive, as input, information on a depth map template selected by a user, controls the graphic processor to extract a depth map of the selected depth map template, and generates a search query including depth information of the extracted depth map.

12. The apparatus as claimed in claim 11, wherein the depth map template includes image data obtained by extracting features of multiple pieces of depth information of an image which have been previously set, and standardizing the extracted features of the multiple pieces of depth information.

13. The apparatus as claimed in claim 9, wherein, when the controller generates the search query including the depth information of the image, the controller controls the display unit to display a depth map generation tool for allowing a user to directly generate a depth map, determines depth map data generated by the depth map generation tool, and generates a search query including depth information of the depth map generated by the depth map generation tool.

14. The apparatus as claimed in claim 13, wherein, when the controller determines the depth map data generated by the depth map generation tool, the controller locates an optional three-dimensional object in a three-dimensional virtual space, places a virtual camera in the three-dimensional virtual space, and extracts a depth map of an image captured by the virtual camera.

15. The apparatus as claimed in claim 14, wherein the depth map generation tool adjusts a position of the virtual camera and a direction in which an image is captured by the virtual camera, and adjusts a shape, a position and a size of the three-dimensional object.

16. The apparatus as claimed in claim 9, wherein, when the controller generates the search query including the depth information of the image, the controller controls the graphic processor to extract a depth map of a previously set image, and generates a search query including depth information of the extracted depth map.

17. The apparatus as claimed in claim 16, wherein the previously set image includes an image captured by a camera or a previously stored image.
